(19) United States
(12) Patent Application Publication
(10) Pub. No.: US 2019/0095483 A1
(43) Pub. Date: Mar. 28, 2019

(54) SEARCH APPARATUS, STORAGE MEDIUM, DATABASE SYSTEM, AND SEARCH METHOD

(71) Applicant: Kabushiki Kaisha Toshiba, Minato-ku (JP)

(72) Inventors: Makoto Shimamura, Kawasaki (JP); Mototaka Kanematsu, Yokohama (JP)

(73) Assignee: Kabushiki Kaisha Toshiba, Minato-ku (JP)

(21) Appl. No.: 16/123,355

(22) Filed: Sep. 6, 2018

Related U.S. Application Data
(63) Continuation of application No. PCT/JP2018/008275, filed on Mar. 5, 2018.

(30) Foreign Application Priority Data
Sep. 26, 2017 (JP) 2017-185362

(51) Int. Cl. G06F 17/30; G06F 17/18

(52) U.S. Cl. CPC G06F 17/30424; G06F 17/30554; G06F 17/18

(57) ABSTRACT

A search apparatus of an embodiment includes a query reception device, a data acquisition device, a decision device, and a determination device. The query reception device receives a query for searching for top N (N is a natural number) cases of data among cases of data that are targets. The data acquisition device acquires n cases of data (n is a natural number equal to or smaller than N) from each of a plurality of nodes distributively holding the cases of data that are targets on the basis of the query received by the query reception device. The decision device decides whether or not the top N cases of data can be settled from the n cases of data acquired by the data acquisition device. The determination device determines a node from which data will be acquired next time from among the plurality of nodes and the number of cases of data to be acquired when the decision device decides that the top N cases of data cannot be settled.

### CROSS REFERENCE TO RELATED APPLICATION

This application is a continuation patent application of International Application No. PCT/JP2018/008275, filed Mar. 5, 2018, which claims priority to Japanese Patent Application No. 2017-185362, filed Sep. 26, 2017. Both applications are hereby expressly incorporated by reference herein in their entireties.

### FIELD

Embodiments described herein relate generally to a search apparatus, a storage medium, a database system, and a search method.

### BACKGROUND

In the related art, a database system that executes a query for acquiring the top N (N is a natural number) cases of data (hereinafter referred to as a top-N query) from a search apparatus connected to a plurality of lower nodes and extracts the top N cases of data from the data stored in the plurality of lower nodes is known. In this database system, the top N cases of data are acquired from M (M is a natural number) lower nodes, the acquired cases of data are merged, and the last N cases of data are extracted. Therefore, transfer of N*M cases of data occurs between the lower nodes and the search apparatus, and only N cases of data among such cases of data are reflected in a query result. Accordingly, transfer for N*(M−1) cases of data is useless and, as a result, a search processing time is likely to increase.

### BRIEF DESCRIPTION OF THE DRAWINGS

FIG. 1 is a diagram illustrating a functional configuration example of a database system 1 according to an embodiment.

FIG. 2 is a diagram illustrating a content of first processing of a query processing device 220 according to a first data acquisition scheme.

FIG. 3 is a diagram illustrating a content of second processing of the query processing device 220 according to the first data acquisition scheme.

FIG. 4 is a diagram illustrating a content of third processing of the query processing device 220 according to the first data acquisition scheme.

FIG. 5 is a diagram illustrating a process of a determination device 224 in a fourth number-of-cases-of-data determination scheme.

FIG. 6 is a diagram illustrating a first example of a cost calculation result.

FIG. 7 is a diagram illustrating a second example of the cost calculation result.

FIG. 8 is a flowchart showing an example of content of a process that is executed by a query processing device 220 of a search apparatus 200.

FIG. 9 is a flowchart showing an example of content of a process in a cost calculation device 225.

FIG. 10 is a diagram illustrating a functional configuration example of a database system 2 in which the search apparatus 200 is configured in a plurality of layers.

### DETAILED DESCRIPTION

An object of the present invention is to provide a search apparatus, a storage medium, a database system, and a search method capable of shortening a search processing time.

A search apparatus according to an embodiment includes a query reception device, a data acquisition device, a decision device, and a determination device. The query reception device receives a query for searching for the top N (N is a natural number) cases of data among cases of data that are targets. The data acquisition device acquires n cases of data (n is a natural number equal to or smaller than N) from each of a plurality of nodes distributively holding the cases of data that are targets on the basis of the query received by the query reception device. The decision device decides whether or not the top N cases of data can be settled from the n cases of data acquired by the data acquisition device. The determination device determines a node from which data will be acquired next time from among the plurality of nodes and the number of cases of data to be acquired when the decision device decides that the top N cases of data cannot be settled.

Hereinafter, a search apparatus, a storage medium, a database system, and a search method according to an embodiment will be described with reference to the drawings.

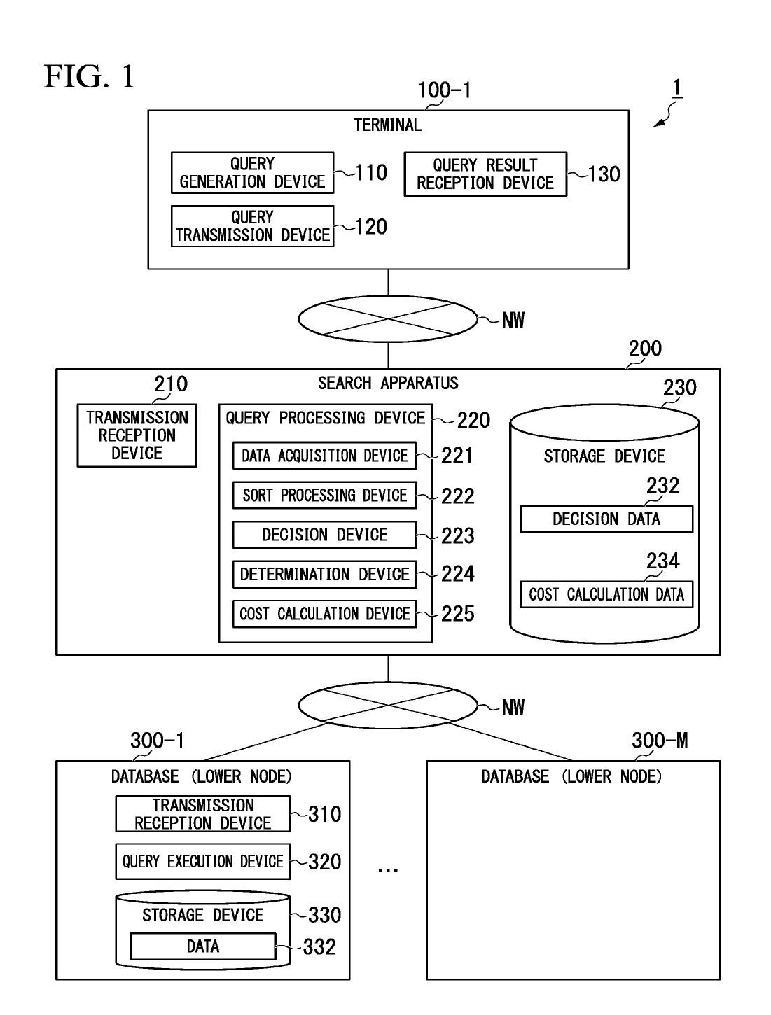

FIG. 1 is a diagram illustrating a functional configuration example of a database system 1 according to the embodiment. The database system 1 illustrated in FIG. 1 includes, for example, a terminal 100, a search apparatus 200, and one or more database devices (an example of a node) 300-1 to 300-M (M is a natural number). The terminal 100, the search apparatus 200, and the database 300 perform communication via a network NW including the Internet, a local area network (LAN), a wide area network (WAN), or the like. It should be noted that in the following description, the databases 300-1 to 300-M have the same configuration, and when the databases 300-1 to 300-M are not distinguished, a hyphen and a subsequent reference signs individually indicating the databases 300-1 to 300-M will be omitted and they will be referred to as “databases 300”.

First, a functional configuration of the terminal 100 will be described. The terminal 100 includes, for example, a query generation device 110, a query transmission device 120, and a query result reception device 130. Each of these components is realized by a hardware processor such as a central processing unit (CPU) executing a program (software). Some or all of these components may be realized by hardware (a circuit unit; including a circuitry) such as a large scale integration (LSI), an application specific integrated circuit (ASIC), a field-programmable gate array (FPGA), or a graphics processing unit (GPU) or may be realized in cooperation between software and hardware.

The query generation device 110 generates a top-N query for acquiring the top or bottom N (N is a natural number) cases of data from the cases of data held in the databases 300-1 to 300-M. The query is, for example, a command indicating an operation with respect to the cases of data held in the database 300. The query is, for example, a command described in a standard query language (SQL). In the following description, it is assumed that the top-N query is a query for acquiring top N cases of data in descending order from cases of data that are targets.

The query transmission device 120 transmits the top-N query generated by the query generation device 110 to the search apparatus 200.

The query result reception device 130 receives the top N cases of data from the search apparatus 200 as a query result obtained through the top-N query transmitted by the query transmission device 120.

Next, a functional configuration of the search apparatus 200 will be described. The search apparatus 200 includes, for example, a transmission reception device 210, a query processing device 220, and a storage device 230. The transmission reception device 210 and the query processing device 220 are realized by a hardware processor such as a CPU executing a program (software). Some or all of these components may be realized by hardware such as an LSI, an ASIC, an FPGA, or a GPU or may be realized in cooperation between software and hardware. Further, the transmission reception device 210 is an example of a “query reception device”.

The transmission reception device 210 receives the top-N query transmitted by the terminal 100. Further, the transmission reception device 210 transmits a query result for the top-N query to the terminal 100. Further, the transmission reception device 210 transmits a query generated by the data acquisition device 221 to the database 300 and receives a query result from the database 300 to which the query has been transmitted.

The query processing device 220 acquires data from the database 300 on the basis of the top-N query received by the transmission reception device 210 and acquires top N cases of data from the acquired data. The query processing device 220 includes, for example, the data acquisition device 221, a sort processing device 222, a decision device 223, a determination device 224, and a cost calculation device 225.

The data acquisition device 221 generates a query for acquiring n (n is a natural number equal to or smaller than N) cases of data among the cases of data that are targets distributively stored in the respective databases 300-1 to 300-M on the basis of the first data acquisition scheme or the second data acquisition scheme determined by the cost calculation device 225.

The first data acquisition scheme is a scheme of setting n to a value smaller than N, acquiring n cases of data among the cases of data that are targets held in the database 300, and repeating this once or a plurality of times to acquire top N cases of data to be finally output. When the data acquisition device 221 acquires the top N cases of data using the first data acquisition scheme, the data acquisition device 221 generates one or more queries. Further, when the data acquisition device 221 generates a query for acquiring data the second time or subsequent times, the data acquisition device 221 generates the query on the basis of the database 300 that is a target determined by the determination device 224 and the number of cases of data to be acquired.

The second data acquisition scheme is a scheme of setting n to a value equal to N, acquiring n cases of data among the cases of data that are targets held in the database 300, and performing this once to acquire final top N cases of data. The data acquisition device 221 generates one query when acquiring the top N cases of data using the second data acquisition scheme.

The data acquisition device 221 transmits the generated query to the databases 300-1 to 300-M and acquires n cases of data from the cases of data that are targets held in the transmitted databases 300-1 to 300-M.

The sort processing device 222 sorts the cases of data acquired in each of the databases 300 that are targets from which the cases of data are acquired, in descending order for each database 300. Further, the sort processing device 222 merges the data sorted for each database 300. Further, the sort processing device 222 may sort the acquired cases of data in ascending order.

The decision device 223 decides whether or not the top N cases of data to be finally output can be settled on the basis of the cases of data sorted by the sort processing device 222. Details of a function of the decision device 223 will be described below.

When the decision device 223 decides that the top N cases of data cannot be settled, the determination device 224 determines the databases 300 from which data is acquired in the next phase. Further, the determination device 224 determines the number of cases of data to be acquired for each of the determined databases 300. Details of a function of the determination device 224 will be described below.

The cost calculation device 225 calculates a cost of each of the first data acquisition method and the second data acquisition scheme that are executed by the data acquisition device 221, and determines the data acquisition scheme to be executed by the data acquisition device 221 on the basis of the calculated cost result. The cost is, for example, a processing time from the transmission of the query from the search apparatus 200 to the database 300 on the basis of the top-N query to the decision that the top N cases of data to be finally output can be settled. The details of a function of the cost calculation device 225 will be described below.

The storage device 230 is realized by a random access memory (RAM), a read only memory (ROM), a hard disk drive (HDD), a flash memory, or the like. For example, decision data 232, cost calculation data 234, and other information are stored in the storage device 230. Content of the decision data 232 and the cost calculation data 234 will be described below. Further, a program to be executed by a hardware processor of the search apparatus 200 may be stored in the storage device 230 in advance or may be downloaded from an external device via the transmission reception device 210. The program may be installed in the storage device 230 when a portable storage medium having the program stored therein is mounted in a drive device (not illustrated).

Next, a functional configuration of the database 300 will be described. The database 300 includes, for example, a transmission reception device 310, a query execution device 320, and a storage device 330. The transmission reception device 310 and the query execution device 320 are realized by a hardware processor such as a CPU executing a program (software). Some or all of these components may be realized by hardware such as an LSI, an ASIC, an FPGA, or a GPU or may be realized in cooperation between software and hardware.

The transmission reception device 310 rcccivcs the query transmitted by the search apparatus 200. Further, the transmission reception device 310 transmits a query result from the query execution device 320 to the search apparatus 200.

The query execution device 320 executes the query received by the transmission reception device 310. For example, the query execution device 320 acquires data corresponding to the query from data 332 stored in the storage device 330. The data 332 includes, for example, numerical values. The numerical value is, for example, a power consumption, the amount of gas use, the amount of water use, a temperature, a humidity, or an amount of money. The data 332 may be record data in which identification information or user information, time information, position information, and the like of the database 300 are associated with the above-described numerical values.

The query execution device 320, for example, acquires the top n cases of data in descending order of the numerical values included in the data 332 or n cases of data from a rank specified by the query.

The storage device 330 is realized by a RAM, a ROM, an HDD, a flash memory, or the like. In the storage device 330, for example, the data 332 and other information are stored. Further, the program executed by the hardware processor of the database 300 may be stored in the storage device 330 in advance or may be downloaded from an external device via the transmission reception device 310. The program may be installed in the storage device 330 when a portable storage medium having the program stored therein is mounted in a drive device (not illustrated).

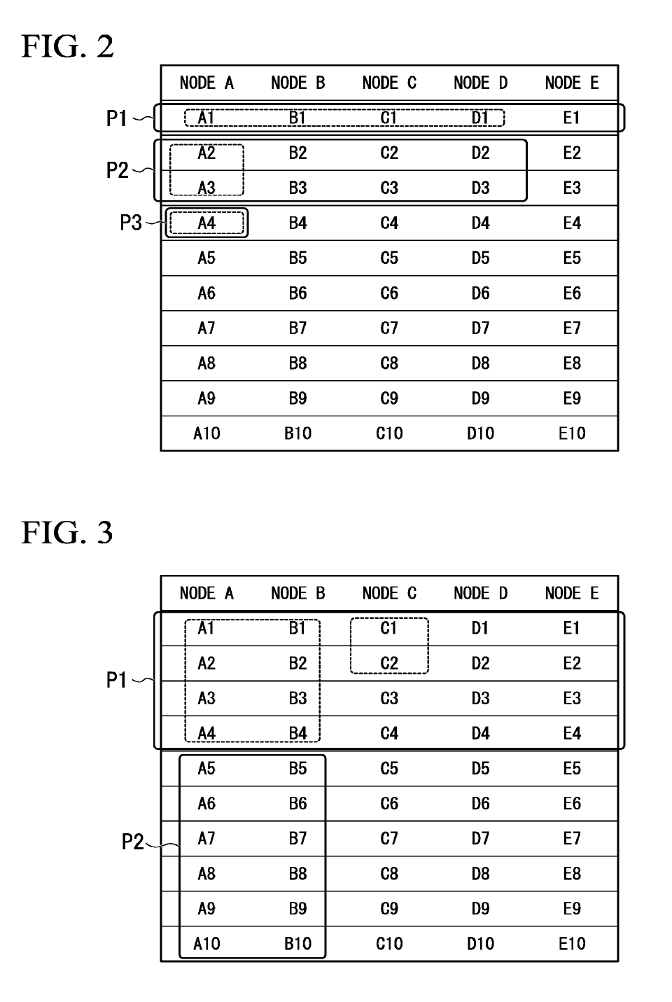

Next, content of a process of the query processing device 220 of the search apparatus 200 will be described. Hereinafter, it is assumed that the nodes A to E correspond to the databases 300-1 to 300-5. Further, it is assumed that A1 to A10, B1 to B10, C1 to C10, D1 to D10, and E1 to E10 illustrated in FIGS. 2 to 4 indicate ten cases of data distributively held in the nodes A to E.

Further, it is assumed that the cases of data held in the respective nodes A to E satisfy A1>A2> . . . >A10, B1>B2> . . . >B10, C1>C2> . . . >C10, D1>D2> . . . >D10, E1>E2> . . . >E10.

FIG. 2 is a diagram illustrating content of first processing of the query processing device 220 according to the first data acquisition scheme. The content of first processing is the content of processing in a case in which the number M of databases 300 in which cases of data that are targets is held is larger than N (N<M) when the top N cases of data are acquired on the basis of the top-N query. A case in which N=4 and M=5 is shown in the example of FIG. 2.

In the content of first processing, first, as a first phase, the data acquisition device 221 acquires the top data from each of nodes A to E one by one (P1 in FIG. 2). The sort processing device 222 merges top five cases of data acquired from the nodes A to E, sorts the merged cases of data, and stores resultant data in the storage device 230 as decision data 232. The decision device 223 extracts the top four cases of data that are candidates (hcrcinaftcr rcfcrrcd to as candidate data) to be finally output, on the basis of the merged cases of data. Further, when all cases of data acquired so far from one node are not included in the candidate data and the top four cases of candidate data can be extracted, the decision device 223 decides that the top four cases of data to be finally output can be settled. Further, when all the cases of data acquired up to the relevant time from one node are included in the candidate data, the decision device 223 decides that the top four cases of data to be finally output cannot be settled.

In the example of FIG. 2, since all the cases of data acquired in the first phase from nodes A to D are included in the candidate data, the decision device 223 decides that the top four cases of data to be finally output cannot be settled. In this case, the determination device 224 determines the nodes A to D from which all of the cases of data have been extracted as candidate data, to be nodes from which data is extracted in the next phase, on the basis of a decision result of the decision device 223. Further, the determination device 224 determines that, for example, two cases of data obtained by doubling the number of cases of data acquired in the first phase are acquired from the determined nodes A to D.

Then, as a second phase, the data acquisition device 221 acquires the top two cases of data among the cases of data that have not yet been acquired from the respective nodes A to D (P2 in FIG. 2). The sort processing device 222 merges the candidate data and the data acquired this time, sorts the merged cases of data, and stores resultant data in the storage device 230 as the decision data 232. The decision device 223 extracts the top four cases of candidate data from the merged cases of data. When all the cases of data acquired so far from one node are not included in the candidate data and the top four cases of candidate data can be extracted, the decision device 223 decides that the top four cases of data to be finally output can be settled. Further, when all the cases of data acquired so far from the one node is included in the candidate data, the decision device 223 decides that the top four cases of data to be finally output cannot be settled.

In the example of FIG. 2, since both cases of data A2 and A3 acquired in the second phase from the node A are included in the candidate data, the decision device 223 decides that the final four cases of data to be finally output cannot be settled. In this case, the determination device 224 determines that the data is acquired from the node A in the next phase on the basis of the decision result of the decision device 223. Further, since the remaining number of unsettled cases is 1, the determination device 224 determines that one piece of data is acquired in the next phase.

Then, as a third phase, the data acquisition device 221 acquires the top one case of data from the cases of data that have not yet been acquired from the node A (P3 in FIG. 2). The sort processing device 222 merges the candidate data and the data acquired this time, sorts the merged cases of data, and stores resultant data in the storage device 230 as the decision data 232. The decision device 223 acquires the top four cases from the merged cases of data. In the example of FIG. 2, the data acquisition device 221 acquires the cases of data A1 to A4 as the top four cases of data to be finally output.

FIG. 3 is a diagram illustrating the content of second processing of the query processing device 220 according to the first data acquisition scheme. The content of second processing is the content of processing in a case in which the number M of databases 300 in which cases of data that are targets is held is smaller than N (N>M) when the top N cases of data are acquired on the basis of the top-N query. A case in which N=10 and M=5 is shown in the example of FIG. 3.

In the content of second processing, as a first phase, the data acquisition device 221 acquires the number of cases of data obtained using a predetermined function. The predetermined function is, for example, 2*(N/M). Therefore, the data acquisition device 221 acquires top four cases (=2*(10/5)) of data from the nodes A to E (P1 of FIG. 3). The sort processing device 222 merges a total of 20 cases of data acquired from the respective nodes, sorts the merged cases of data, and stores resultant data in the storage device 230 as the decision data 232. The decision device 223 extracts the top ten cases of candidate data from the merged cases of data. Further, when all of the four cases of data acquired from each of the nodes A to E are not included in the candidate data and the top ten cases of candidate data can be extracted, the decision device 223 decides that the top ten cases to be finally output can be settled. Further, when the four cases of data acquired from one node are included in the candidate data, the decision device 223 decides that the top ten cases of data to be finally output cannot be settled.

In the example of FIG. 3, the four cases of data acquired in the first phase from the node A and the node B are included in the candidate data. Therefore, the decision device 223 decides that the top ten cases of data to be finally output cannot be settled. In this case, the determination device 224 determines that data is acquired from the node A and the node B in the next phase on the basis of the decision result of the decision device 223. Further, the determination device 224 determines that eight cases of data, twice the four cases of data are acquired in the next phase. It should be noted that since the number of remaining cases of data of each of the nodes A and B is 6, six cases of data are, as a result, acquired from each of the node A and the node B.

Then, as a second phase, the data acquisition device 221 acquires cases of data of A5 to A10 and B5 to B10 which have not yet been acquired from the node A and the node B (P2 in FIG. 3). The sort processing device 222 merges the candidate data and the data acquired this time, sorts the merged cases of data, and stores resultant data in the storage device 230 as the decision data 232. The decision device 223 extracts the top ten cases of candidate data from the merged cases of data. In the example of FIG. 3, the data acquisition device 221 acquires the cases of data A1 to A4, B1 to B4, and C1 to C2 as the top ten cases to be finally output.

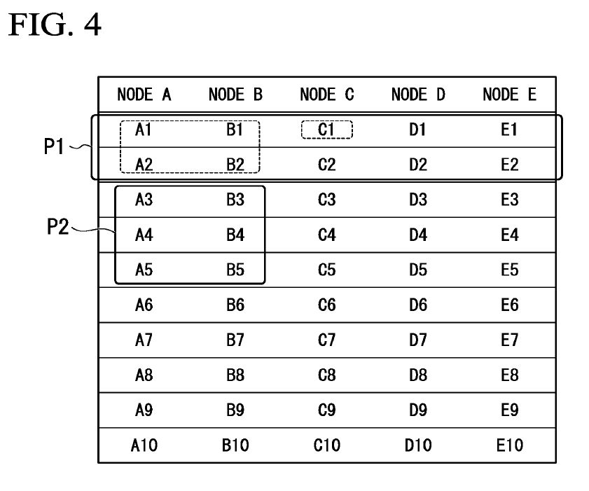

FIG. 4 is a diagram illustrating the content of third processing of the query processing device 220 according to the first data acquisition scheme. The content of third processing is the content of processing in a case in which the number M of databases 300 in which cases of data that are targets is held is equal to N when the top N cases of data are acquired on the basis of the top-N query. A case in which N=5 and M=5 is shown in the example of FIG. 4.

In the content of third processing, first, as a first phase, the data acquisition device 221 acquires two (=2*(5/5)) cases of data from the top cases of data of the nodes A to E on the basis of a prcdctcrmincd function (P1 in FIG. 4). The sort processing device 222 merges a total of ten cases of data acquired from the respective nodes, sorts the merged cases of data, and stores resultant data in the storage device 230 as the decision data 232. The decision device 223 extracts top five cases of candidate data from the merged cases of data. Further, when all of the two cases of data acquired from the respective nodes A to E are not included in the candidate data, the decision device 223 decides that the top five cases of data to be finally output can be settled. Further, when all the cases of data acquired from one node is included in the candidate data, the decision device 223 decides that the five cases of data to be finally output cannot be settled. In the example of FIG. 4, both of the two cases of data acquired from the node A and the node B are included in the candidate data. Therefore, the decision device 223 decides that the top ten cases of data to be finally output cannot be settled. In this case, the determination device 224 determines that data is acquired from the node A and the node B in the next phase on the basis of the decision result of the decision device 223. Further, the determination device 224 determines that three cases of data other than the two cases of data among the top 5 cases of data are acquired in the next phase.

Then, as a second phase, the data acquisition device 221 acquires the top three cases of data A3 to A5 and B3 to B5 that have not yet been acquired from the node A and the node B (P2 in FIG. 4). The sort processing device 222 merges the candidate data with A3 to A5 and B3 to B5 acquired in the current phase, sorts the merged cases of data, and stores resultant data in the storage device 230 as the decision data 232. The decision device 223 acquires the top five cases of data to be finally output from the merged cases of data.

It is possible to sufficiently shorten the amount of data transfer or the transfer time with respect to the lower nodes by acquiring the top N cases of data from the cases of data that are targets according to the above content of the process. Further, since the time taken to merge or sort data is shortened according to the content of the process described above, it is possible to shorten, as a result, a search processing time.

Next, number-of-cases-of-data determination schemes in the determination device 224 will be described. For example, the determination device 224 determines the number n(k) of cases of data using first to fourth number-of-cases-of-data determination schemes to be shown below in the phase number k.

The first number-of-cases-of-data determination scheme is a scheme of increasing the number of cases of data by a constant multiple according to the phase number k. In this case, the determination device 224 calculates, for example, the number n(k) of cases of data acquired in the next phase to be n(k−1)*2, which is twice the number of cases of data acquired in the previous phase.

The second number-of-cases-of-data determination is a method of adding a constant X according to the phase number k. In this case, the determination device 224 calculates the number n(k) of cases of data to be acquired in the next phase to be n(k−1)+X. In the first and second number-of-cases-of-data determination schemes described above, the determination device 224 gradually increases the number of cases of data to be acquired according to the phase number k within a range not exceeding N.

The third number-of-cases-of-data determination scheme is a scheme of calculating a probability of entering the second and subsequent phases on the basis of the execution history of the same type of top-N queries executed so far, and determining the number n(K) of cases of data on the basis of the calculated probability. The same type of top-N queries are, for example, top-N queries that are executed under a condition that a type and the number of cases of data to be acquired and the number M of the databases 300 are the same. In this case, the determination device 224 calculates the number n(k) of cases of data to be acquired in the next phase using a predetermined function “p*n(k−1)” including a possibility variable p.

The possibility variable p will be described herein. First, the determination device 224 sets an initial value of the possibility variable p to p0 and executes the top-N query k times. An execution result may be stored in the storage device 230 as history information. When the determination device 224 has not executed the processes of the second phase and subsequent phases on the basis of the execution result, the determination device 224 decreases the value of the possibility variable p as p=p_{old}*A1 (A1<1). P_{old} is a value of the possibility variable p used in the previous top-N query. Further, the determination device 224 executes the top-N query k times, and increases the value of the variable p as p=p_{old}*A2 (A2>1) when the probability of entering the second phase is higher than a reference probability PΦ2.

For example, it is assumed that the initial value p0=2, the number k of executions=10, A1=0.9, A2=1.2, and the reference probability PΦ2=0.2 are set. When the top-N query is executed ten times and the second phase is not executed, the determination device 224 sets the possibility variable p=2*0.9=1.8 and applies the possibility variable p to the number of cases of data n(k)=p*n(k−1) to determine the number of cases of data. Further, when the top-N query is executed ten times and the second phase is executed twice, the determination device 224 sets the possibility variable p=2*1.2=2.4 and applies the possibility variable p to the number of cases of data n(k)=p*n(k−1) to determine the number of cases of data. Thus, since the number of cases of data to be acquired can be adjusted on the basis of the execution history of the top-N query using the third number-of-cases-of-data determination scheme, it is possible to suppress useless transfer of data.

The fourth number-of-cases-of-data determination scheme is a scheme of calculating a coefficient r at which a sum of the number of cases of data to be acquired is minimized when it is assumed that data is acquired on the basis of a predetermined number of repetitions, and determining the number of cases of data when the top-N query is actually executed, on the basis of the calculated coefficient r. In this case, the determination device 224 obtains a minimum coefficient r using an equation of a sum of a geometric progression “a(1−rⁿ)/(1−r)>N (a is the number of cases of data in the first phase)”. Further, the determination device 224 may obtain the coefficient r through approximation based on numerical analysis using Newton's method or the like.

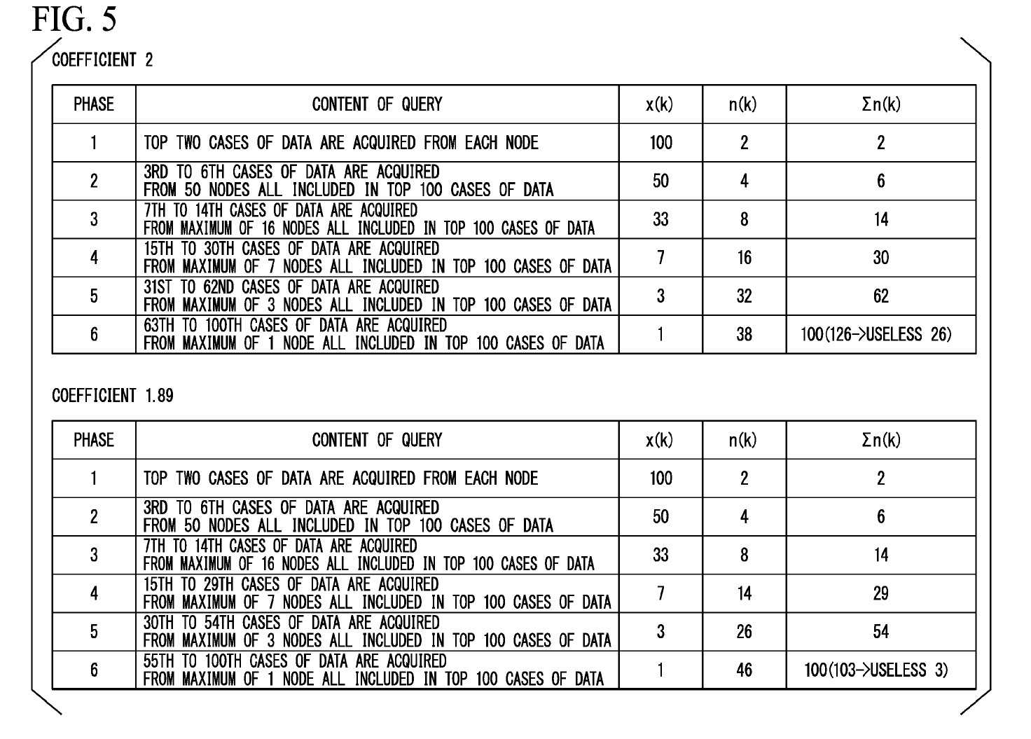

FIG. 5 is a diagram illustrating a process of the determination device 224 in the fourth number-of-cases-of-data determination scheme. In the example of FIG. 5, the content of the query, the number of nodes x(k), the number n(k) of cases of data, and a sum Σn(k) of the number n(k) of cases of data for each phase when data acquisition is executed with coefficients r=2 and 1.89 in a case in which the number of cases of databases 300 in which top 100 cases of data are acquired is set to 100 and the number of repetitions is set to 6 are shown.

For example, as illustrated in an upper diagram of FIG. 5, when the coefficient r=2, a sum of the number of cases of data acquired up to the sixth phase is 126 and useless data is 26, whereas in the case of the coefficient p=1.89 illustrated in a lower diagram of FIG. 5, a sum of the number of cases of data acquired up to the sixth phase is 103 and the number of useless cases of data is 3. When the two cases of data are compared with each other, the number of useless cases of data when the coefficient r is 1.89 is smaller than that when the coefficient is 2. Thus, in the fourth number-of-cases-of-data determination scheme, tentative data acquisition is executed using a plurality of coefficient values and the numbers of cases of data acquired through the execution are compared with each other such that an appropriate coefficient r can be set. Further, it is possible to suppress useless data acquisition by determining an actual number of cases of data using the set coefficient r.

Next, a function of the cost calculation device 225 will be described. The cost calculation device 225 calculates a cost of each of the first data acquisition scheme and the second data acquisition scheme. The cost calculation device 225 determines a data acquisition scheme in the data acquisition device 221 on the basis of each of the calculated costs.

For example, the cost calculation device 225 first receives the top-N query via the transmission reception device 210, acquires the top N cases of data from all the databases 300 using the second data acquisition scheme at the time of execution of first-time processing of the top-N query in the query processing device 220, merges and sorts the acquired cases of data, and calculates a processing time until the top N cases of data to be finally output are acquired. Further, the cost calculation device 225 is not limited to the time of execution of the first-time processing of the top-N query, but may calculate the above-described processing time in advance at a predetermined timing. Further, the cost calculation device 225 sets the calculated processing time as the cost of the second data acquisition scheme. The cost calculation device 225 stores the cost of the second data acquisition scheme in the storage device 230 as the cost calculation data 234.

Further, the cost calculation device 225 estimates the cost in the first data acquisition scheme on the basis of the processing time calculated using the cost calculation data 234. The cost calculation device 225 compares the cost of the first data acquisition scheme with the cost of the second data acquisition scheme and causes the data acquisition device 221 to acquire the data using the data acquisition scheme with a smaller cost.

A specific cost calculation scheme will be described herein. First, as a premise, it is assumed that a query execution processing time in the database 300 is the same between the first data acquisition scheme and the second data acquisition scheme. The cost calculation device 225 calculates “a sorting time S of data in the sort processing device 222”, “a data acquisition command transfer time Q to the database 300”, and “a total data transfer time T” using the second data acquisition scheme at the time of the first-time processing of the top-N query. The sorting time S is a value obtained by adding a fixed time Sfix such as a time to activate a sort function to a time Sf(n) that depends on the amount of data. Further, the cost calculation device 225 sets a sum of the sorting time S and the data acquisition command transfer time Q as an evaluation value and determines one of the first and second data acquisition schemes on the basis of a result of comparing the evaluation value with the total data transfer time T which is an example of a threshold value.

For example, the cost calculation device 225 assumes that a maximum of k phases are required in the data acquisition using the top-N query, and calculates x(i+1)=floor (N/(n(i)*x(i)) using “the number of cases of data n(i) transferred by the database 300 in an i-th phase” and “a maximum value x(i) of the number of nodes in which all the cases of data transferred in the i-th phase are included in the candidate data. The floor is a function that truncates decimal places.

Further, the cost calculation device 225 calculates a difference between the sorting times in the first data acquisition scheme, ΔS=(k−1)*Sfix+Sf(Σ{i∈{1˜k}}(x(i)*n(i))/(N*M) using Sfix and Sf(n). Further, the cost calculation device 225 calculates an increment of the data acquisition command transfer time in the first data acquisition scheme, ΔQ=(k−1)*Q. Further, the cost calculation device 225 calculates a difference between the total data transfer times in the first data acquisition scheme, ΔT=T−(Σ{i∈{1˜k}}(x(i)*n(i)*T/(N*M))). The cost calculation device 225 compares a sum of ΔS and ΔQ obtained as results of these calculations with ΔT, determines that the first data acquisition scheme is used when the sum of ΔS and ΔQ is smaller than ΔT, and determines that the second data acquisition scheme is used when the sum of ΔS and ΔQ is equal to or greater than ΔT.

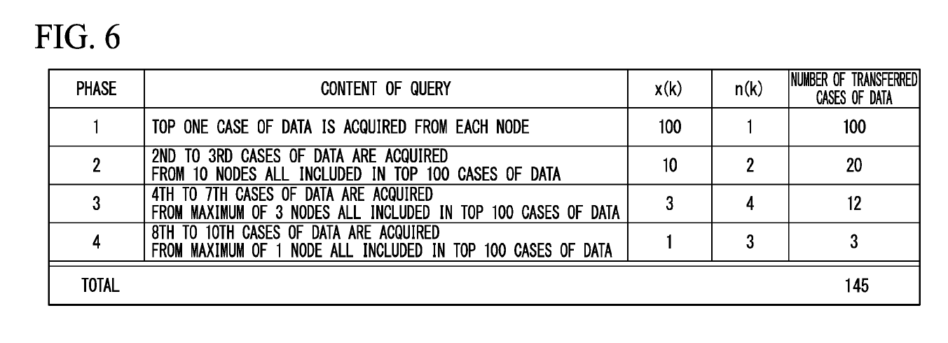

FIG. 6 is a diagram illustrating a first example of the cost calculation result. In the example of FIG. 6, the content of the query, x(k), n(k), and the number of transferred cases of data are associated with each phase k. For example, it is assumed that the number of transferred cases of data is 145 when N=10, M=100, Sfix=1 [ms], Sf(n)=9 [ms], Q=10 [ms], and T=1000 [ms] are set and the first to fourth phases are executed. In this case, the cost calculation device 225 calculates

ΔS=(4−1)*1+145/1000*9=4.3 [ms],

ΔQ=(4−1)*10=30 [ms], and

ΔT=1000−(145/1000)*1000=855 [ms].

As a result, a relationship “ΔS+ΔQ<ΔT” is satisfied for ΔS, ΔQ, and ΔT. Therefore, the cost calculation device 225 determines that the first data acquisition scheme is used for the data acquisition in the data acquisition device 221.

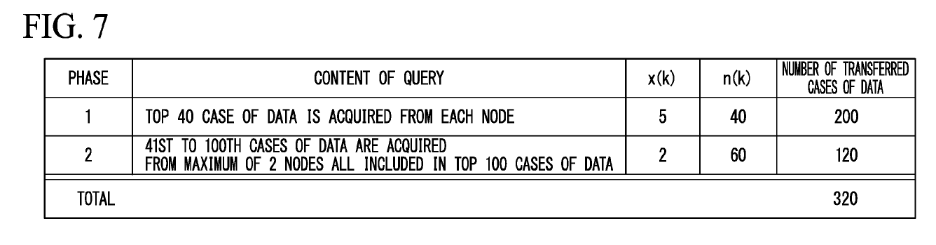

FIG. 7 is a diagram illustrating a second example of the cost calculation result. In the example of FIG. 7, the content of the query, x(k), n(k), and the number of transferred cases of data are associated with each phase. For example, it is assumed that the number of transferred cases of data is 320 when N=100, M=5, Sfix=10 [ms], Sf(n)=990 [ms], Q=10 [ms], and T=100 [ms] are set and the first phase and the second phase are executed. In this case, the cost calculation device 225 calculates

ΔS=(2−1)*10+320/500*990−1000=414 [ms],

ΔQ=(2−1)*10=10 [ms], and

ΔT=100−(320/500)*100=360 [ms].

As a result, a relationship “ΔS+ΔQ≥ΔT” is satisfied for ΔS, ΔQ, and ΔT. Therefore, the cost calculation device 225 determines that the second data acquisition scheme is used for the data acquisition in the data acquisition device 221.

It is possible to shorten the data transfer time, and as a result, to shorten the search processing time by switching the data acquisition scheme on the basis of the cost calculated by the cost calculation device 225 as described above.

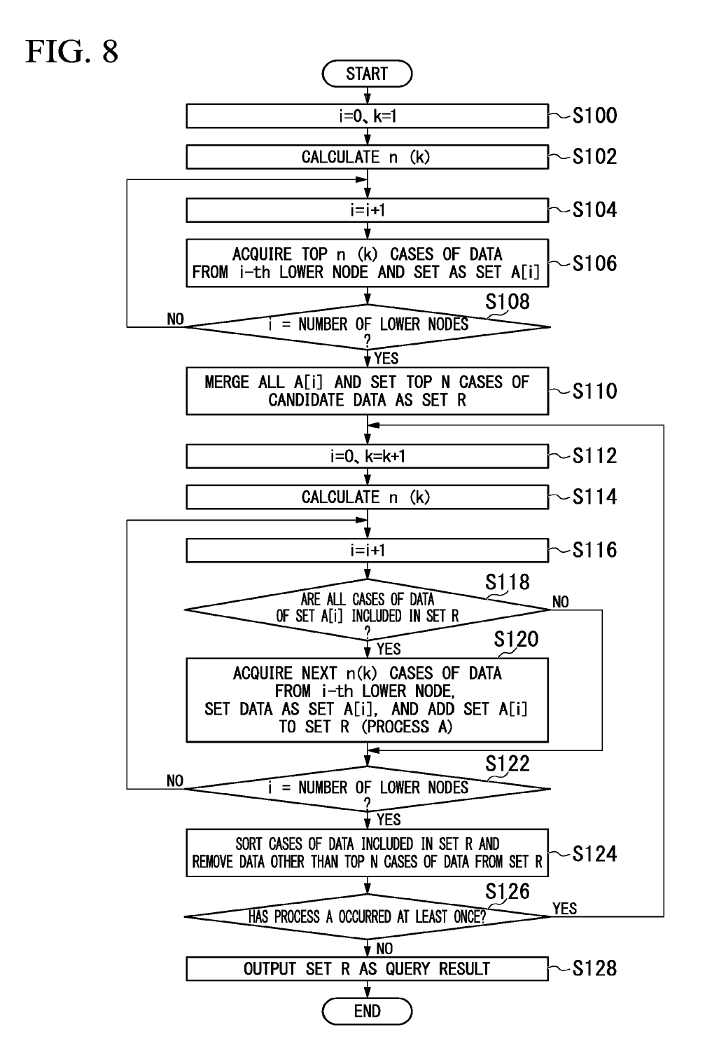

Next, content of various processes executed by the search apparatus 200 according to the embodiment will be described with reference to a flowchart. In the following flow, a lower node is the database 300. FIG. 8 is a flowchart showing an example of content of a process that is executed by the query processing device 220 of the search apparatus 200. In the example of FIG. 8, a process of acquiring top N cases of data among the cases of data that are targets distributively held in the lower data using the first data acquisition scheme is shown.

First, the data acquisition device 221 sets 0 in a variable i for identifying the lower node and 1 in a variable k for identifying the phase number, as initial values (step S100). Then, the data acquisition device 221 calculates the number n(k) of cases of data to be acquired (step S102). The data acquisition device 221 then adds 1 to the variable i (step S104), acquires top n(k) cases of data from an i-th lower node, and sets the acquired data as a set A[i] (step S106).

Then, the data acquisition device 221 decides whether or not the value of the variable i is equal to the number of lower nodes (step S108). When it is decided that the value of the variable i is not equal to the number of lower nodes, the process returns to the process of step S104. Further, when it is decided that the variable i is equal to the number of lower nodes, the sort processing device 222 merges all the A[i] and sets the top N cases of candidate data as a set R (step S110).

Then, the decision device 223 sets 0 in the variable i and adds 1 to the phase number k (step S112). Then, the determination device 224 calculates the number n(k) of cases of data to be acquired from the lower nodes in the next phase (step S114). Then, the decision device 223 adds 1 in the variable i (step S116) and determines whether or not all cases of data of the set A[i] are included in the set R of candidate data (step S118). When the decision device 223 decides that all the cases of data of the set A[i] are included in the set R, the decision device 223 acquires the next n(k) cases of data from the i-th lower node, sets the data as the set A[i], and adds the set A[i] to the set R of candidate data (step S120). The process of step S120 is hereinafter referred to as process A.

When it is decided that all cases of data of the set A[i] are not included in the set R after the process of step S120 or in the process of step S118, it is decided whether or not the value of the variable i is equal to the number of lower nodes (step S122). When it is decided that the value of the variable i is not equal to the number of lower nodes, the process returns to the process of step S116. Further, when it is decided that the variable i is equal to the number of lower nodes, the sort processing device 222 sorts the cases of data included in the set R and removes data other than the top N cases of data from the set R (step S124).

Then, the determination device 224 decides whether or not process A in step S120 described above has occurred at least once (step S126). When it is decided that process A has occurred at least once, the process returns to step S112. When the process returns to the process of step S112, the number of executions of process A is initialized to 0 and step S112 and the subsequent processes are executed. Further, when process A has not occurred at least once, the decision device 223 outputs the set R as a last query result of the top-N query (step S128). Accordingly, the process of this flowchart ends.

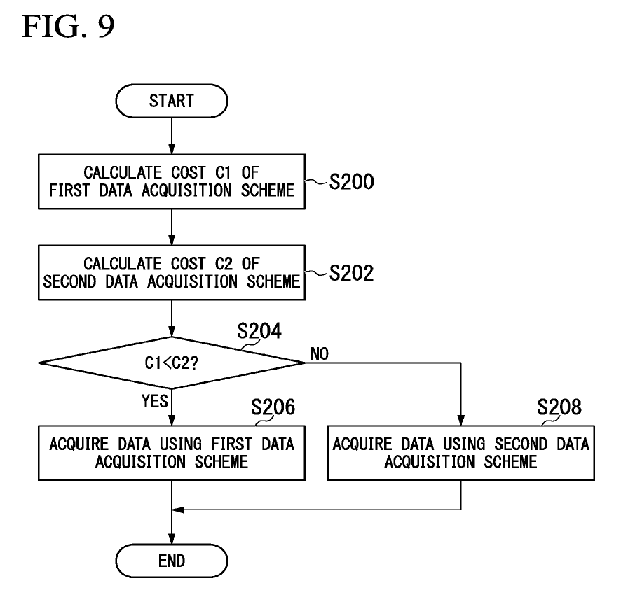

FIG. 9 is a flowchart showing an example of content of a process in the cost calculation device 225. It should be noted that in the example of FIG. 9, cost calculation in the second data acquisition scheme has already been performed. In the example of FIG. 9, the cost calculation device 225 calculates a cost C1 of data acquisition using the first data acquisition scheme (step S200) and calculates a cost C2 of the data acquisition using the second data acquisition scheme (step S202).

Next, the cost calculation device 225 decides whether or not the acquired cost C1 is smaller than the cost C2 (step S204). When it is decided that the cost C1 is smaller than the cost C2, the cost calculation device 225 determines that the first data acquisition scheme is used for the data acquisition using the data acquisition device 221 (step S206). Further, when it is decided that the cost C1 is equal to or greater than the cost C2, the cost calculation device 225 determines that the second data acquisition scheme is used for the data acquisition (step S208).

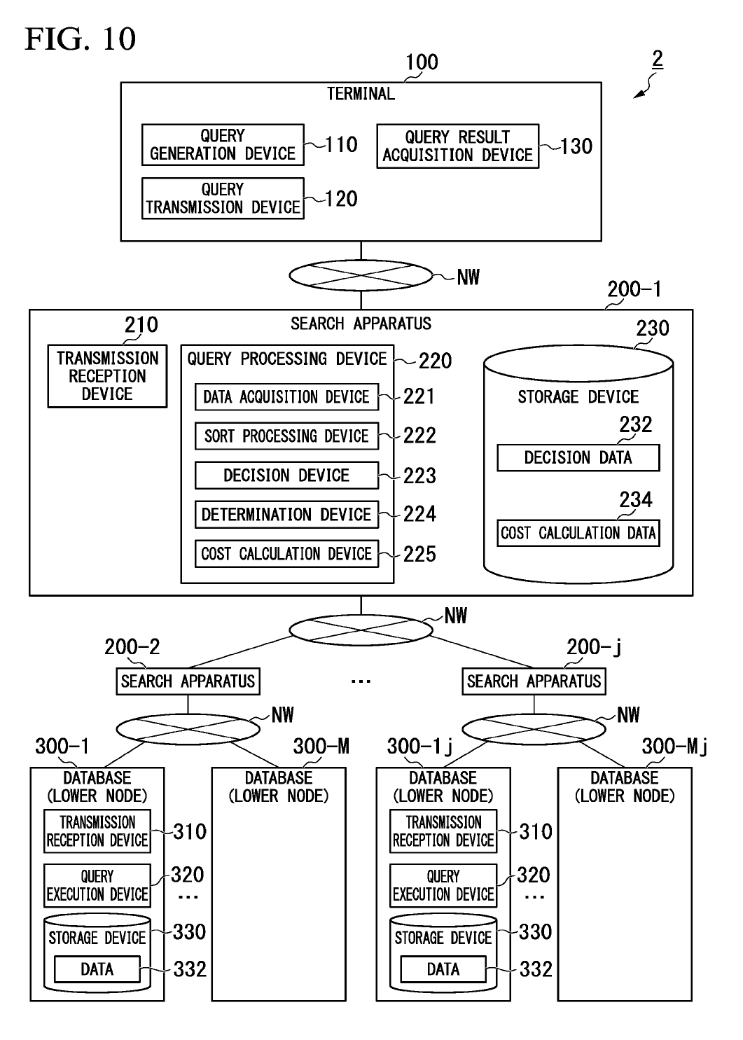

Further, the database system 1 according to the embodiment may include a plurality of terminals 100 or may include a plurality of search apparatuses 200. Further, in the database system of the embodiment, the search apparatuses 200 may be configured a plurality of layers. FIG. 10 is a diagram illustrating a functional configuration example of a database system 2 in which the search apparatus 200 is structured in a plurality of layers. The database system 2 illustrated in FIG. 10 includes a plurality of search apparatuses 200-1 to 200-J (J is a natural number equal to or greater than 2) as compared with the database system 1 illustrated in FIG. 1. The search apparatus 200-2 to 200-J are connected as lower devices of the search apparatus 200-1 via a network NW.

In the database system 2 illustrated in FIG. 10, when a top-N query is received from a terminal 100, the search apparatus 200-1 transmits the top-N query to each of the lower search apparatuses 200-2 to 200-J. Using the first data acquisition scheme and the second data acquisition scheme described above, the lower search apparatuses 200-2 to 200-2 extract top N cases of data and transmit the extracted cases of data to the search apparatus 200-1. The top N cases of data to be finally output are acquired on the basis of respective search results obtained by receiving search results of the top N cases of data, and the acquired cases of data are transmitted to the terminal 100. It should be noted that although the search apparatus 200 is configured in two layers in the database system 2 illustrated in FIG. 10, the search apparatus 200 may be configured in three or more layers.

According to at least one embodiment described above, the search apparatus 200 includes the transmission reception device 210 that receives the query for searching for top N (N is a natural number) cases of data among cases of data that are targets, the data acquisition device 221 that acquires n cases of data (n is a natural number equal to or smaller than N) from each of the plurality of nodes distributively holding the cases of data that are targets on the basis of the query received by the transmission reception device 210, the decision device 223 that decides whether or not the top N cases of data can be settled from the n cases of data acquired by the data acquisition device, and the determination device 224 that determines a node from which data will be acquired next time from among the plurality of nodes and the number of cases of data to be acquired when the decision device 223 decides that the top N cases of data cannot be settled. Thus, it is possible to efficiently search for the top N cases of data among the cases of data that are targets distributed in the plurality of databases 300-1 to 300-3 and to shorten the search process time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A search apparatus comprising:
a query reception device that receives a query for searching for top N (N is a natural number) cases of data among cases of data that are targets;
a data acquisition device that acquires n cases of data (n is a natural number equal to or smaller than N) from each of a plurality of nodes distributively holding the cases of data that are targets on the basis of the query received by the query reception device;
a decision device that decides whether or not the top N cases of data can be settled from the n cases of data acquired by the data acquisition device; and
a determination device that determines a node from which data will be acquired next time from among the plurality of nodes and the number of cases of data to be acquired when the decision device decides that the top N cases of data cannot be settled.

2. The search apparatus according to claim 1, wherein the data acquisition device repeats a process of acquiring the number of cases of data determined by the determination device from the node determined by the determination device until the decision device decides that the top N cases of data can be settled.

3. The search apparatus according to claim 1, wherein when the decision device decides that the top N cases of data cannot be settled, the determination device determines a node in which all of the cases of data acquired this time are included in the top N cases to be a node from which data will be acquired next time.

4. The search apparatus according to claim 1, wherein the determination device gradually increases the number n of cases of data to be acquired within a range not exceeding N when the decision device decides that the top N cases of data cannot be settled.

5. The search apparatus according to claim 1, wherein when the decision device decides that the top N cases of data cannot be settled, the determination device determines the number n of cases data to be acquired from the node from which the data will be acquired next time on the basis of the number of cases of data acquired by the data acquisition device, the number of cases of data output as a query result, and the number of the plurality of nodes.

6. The search apparatus according to claim 1, wherein the determination device calculates a probability of a plurality of acquisitions of data having been executed on the basis of an execution history of the query and determines the number of cases of data n to be acquired from the node on the basis of the calculated probability.

7. The search apparatus according to claim 1, wherein the determination device calculates a coefficient at which the number of cases of data to be acquired is minimized when data is assumed to be acquired on the basis of a predetermined number of repetitions, and determines the number of cases of data on the basis of the calculated coefficient.

8. The search apparatus according to claim 1, wherein the data acquisition device acquires a processing time until the top N cases of data will be acquired from the plurality of nodes in advance and acquires the top N cases of data from all of the plurality of nodes when an evaluation value calculated on the basis of the acquired processing time is equal to or smaller than a threshold value.

9. The search apparatus according to claim 1, wherein the data acquisition device acquires a processing time until the top N cases of data will be acquired when the query is first received by the query reception device, and acquires the top N cases of data from all of the plurality of nodes when an evaluation value calculated on the basis of the acquired processing time is equal to or smaller than a threshold value.

10. A non-transitory computer-readable storage medium storing a computer program:
receive a query for searching for top N (N is a natural number) cases of data among cases of data that are targets;
acquire n cases of data (n is a natural number equal to or smaller than N) from each of a plurality of nodes distributively holding the cases of data that are targets on the basis of the received query;
decide whether or not the top N cases of data can be settled from the n acquired cases of data; and
determine a node from which data will be acquired next time from among the plurality of nodes and the number of cases of data to be acquired when it is decided that the top N cases of data cannot be settled.

11. A database system comprising a search apparatus and a plurality of nodes,
wherein the search apparatus includes
a query reception device that receives a query for searching for top N (N is a natural number) cases of data among cases of data that are targets;
a data acquisition device that acquires n cases of data (n is a natural number equal to or smaller than N) from each of a plurality of nodes distributively holding the cases of data that are targets on the basis of the query received by the query reception device;
a decision device that decides whether or not the top N cases of data can be settled from the n cases of data acquired by the data acquisition device; and
a determination device that determines a node from which data will be acquired next time from among the plurality of nodes and the number of cases of data to be acquired when the decision device decides that the top N cases of data cannot be settled, and
the node includes
a storage device that stores the cases of data that are targets; and
a query execution device that executes the query received from the search apparatus to acquire n cases of data from the cases of data that are targets stored in the storage device, and transmits the acquired data to the search apparatus.

12. A search method comprising:
receiving, by a computer of a search apparatus, a query for searching for top N (N is a natural number) cases of data among cases of data that are targets;
acquiring, by the computer, n cases of data (n is a natural number equal to or smaller than N) from each of a plurality of nodes distributively holding the cases of data that are targets on the basis of the received query;
deciding, by the computer, whether or not the top N cases of data can be settled from the n acquired cases of data; and
determining, by the computer, a node from which data will be acquired next time from among the plurality of nodes and the number of cases of data to be acquired when it is decided that the top N cases of data cannot be settled.
